(19) United States
(12) Patent Application Publication
(10) Pub. No.: US 2012/0234256 A1
(43) Pub. Date: Sep. 20, 2012

(54) MECHANICAL CONFLICT DEVICE

(76) Inventors: Steven E. Harte, Livonia, MI (US); Thomas J. Morrow, Bellaire, MI (US)

(21) Appl. No.: 13/498,510

(22) PCT Filed: Sep. 28, 2010
(86) PCT No.: PCT/US10/50510

§ 371 Date: Jun. 5, 2012

Related U.S. Application Data
(60) Provisional application No. 61/246,390, filed on Sep. 28, 2009.

(51) Int. Cl. A01K 1/03

(52) U.S. Cl. 119/421

(57) ABSTRACT

The present technology provides a mechanical conflict device operable to assess a physiologic experience; for example, pain or drug addiction in an animal, the device comprising: a housing having a floor connected to a plurality of walls, the floor and plurality of walls defining: a holding compartment, an alley compartment connected to the holding compartment, the alley compartment has a plurality of perforations disposed on the floor of the alley compartment, and a compensatory compartment connected to the alley compartment. The compensatory compartment is operable to provide a positive stimulus to the animal. The device also includes a noxious mechanical stimulus the noxious mechanical stimulus having a platform, a plurality of pins disposed on the platform and a platform raising mechanism capable of raising the plurality of pins through the plurality of perforations in the floor of the alley compartment.

### FIELD

The present disclosure relates to a device and methods for measuring acute and chronic tactile nociception and analgesic efficacy in laboratory animals.

### INTRODUCTION

This section provides background information related to the present disclosure which is not necessarily prior art.

Through the use of physiological, biochemical, and molecular techniques, animal pain researchers have elucidated the cellular mechanisms of drug action and tolerance, pain-induced neural plasticity, and the role of glia in chronic pain. Candidate gene and genome-wide association studies in chronic pain patients have begun to identify associations between several common polymorphisms and pain sensitivity.

Enthusiasm for this bounty of new information has been subdued, however, by an inability to translate this information into improvements in clinical pain medicine. With the exception of a few antiepileptic and antidepressant drugs that gained recent approval as pain treatments, almost no novel analgesics have been introduced in the last 30 years. However, this is not due to a lack of trying on the part of pain researchers. A notable example is that of the failed clinical trials assessing substance-P NK1 receptor antagonists as analgesics. Converging data from human and animal studies indicate that substance-P plays an important role in pro-nociceptive processing, and it was predicted that the blockade of substance-P receptors would result in analgesia. NK1 receptor antagonists, such as LY 303870, did relieve persistent and neuropathic pain in animal studies, but failed in the clinic against human neuropathic pain. In addition to NK1 receptor antagonists, many other compounds that have shown promise in preclinical studies have also failed to produce analgesia in clinical pain conditions. Many factors have been suggested to contribute to this lack of clinical translation: animals and humans process and modulate noxious stimulation differently by engaging different pathways and brain structures; receptor-level drug transduction and signaling cascades differ between species; animal models of pain fail to mimic their human counterparts; and pain assessment methods at the preclinical level are flawed.

Animal pain studies involve a manipulation (e.g., surgery, injections, etc.) intended to produce, suppress, or modulate a pain-like state in the animal and the measurement of some behavior believed to be indicative of that pain state. An example of a device and method for determining responses to pain stimuli include the “Plantar Test (Hargreaves Method)” testing device. This device has been adopted for use with mice and rats and has been commercialized in several iterations that measure the animal's pain reflex response. Examples of devices further include mechanical and thermal pain assessment devices, including The Dynamic Plantar Aesthesiometer manufactured by Ugo Basile, Comerio, Italy and the IITC Plantar Analgesia Meter manufactured by IITC Life Science Inc., Woodland Hills, Calif., USA.

As a representative example of these types of devices, the IITC Plantar Analgesia Meter operates by providing a thermal nociceptive stimulus originating from a focused projection bulb mounted in a stimulus tower that is manually manipulated in a two-dimensional axis on ball bearing slides to permit the stimulus to be delivered separately to either hind paw of each test subject. The stimulus can be positioned under the foot pad with the aid of an angled mirror mounted on the stimulus source, permitting an exact visual targeting of the stimulation site prior to stimulus initiation. A timer is automatically actuated with the light source, and response latency is defined as the time required for the paw to show an abrupt withdrawal. Paw withdrawal is detected by motion sensors mounted on the stimulus tower that stops the timer and terminates the stimulus. Stimulus current from a regulated source is monitored continuously to determine the amperage delivered to the light source and, thereby, the magnitude of the radiant stimulus to which the paw is subjected.

Many compounds that have demonstrated analgesic properties in preclinical models have failed to translate to clinical efficacy. One potential reason for this translational failure is that the reflexive responses to acute noxious stimuli that are typically measured in preclinical studies using reflex-pain devices, as exemplified above, do not adequately reflect the complexity of human chronic pain. Historically, pain research in animals has relied on measures of innate reflexes that do not require brain processing or learning. The wide-spread use of reflex measures has been justified by their technical simplicity and efficiency. However, it has been argued that reflex measures as indicators of chronic pain states are intrinsically flawed because they do not represent the perceptual experience of pain, which is composed of sensory, affective/motivational, and cognitive components. Furthermore, reflex tests are neither sensitive nor specific predictors of drug efficacy in human trials.

The adoption of paradigms that measure spontaneous, complex and/or organized behaviors that are sensitive to the modulation of pain processing throughout the neuraxis is now seen to be an important inclusion in pain related research. Hence, a device that is operable to adopt these paradigms in its operation will enable a better assessment of acute and chronic nociception in preclinical animal models and will be of greater clinical importance.

### SUMMARY

This section provides a general summary of the disclosure, and is not a comprehensive disclosure of its full scope or all of its features.

The present technology provides a mechanical conflict device (MCD) operable to assess a physiologic experience, for example pain or drug addiction in an animal, the device comprising: a housing having a floor connected to a plurality of walls, the floor and plurality of walls defining: a holding compartment, an alley compartment connected to the holding compartment, the alley compartment has a plurality of perforations disposed on the floor of the alley compartment, and a compensatory compartment connected to the alley compartment. The compensatory compartment is operable to provide a positive stimulus to the animal. The device also includes a noxious mechanical stimulus having a platform, a plurality of pins disposed on the platform and a platform raising mechanism capable of raising the plurality of pins through the plurality of perforations in the floor of the alley compartment.

In a further aspect, the present technology also provides methods for determining the mechanical sensitivity and behavioral responses of an animal to noxious mechanical stimuli using the MCD of the present technology. For example, the MCD can be used in methods to measure variables such as: 1) Latency to Exit Light Chamber, 2) Latency to Enter Dark Chamber, and/or 3) Duration of Initial Cross or Total Time Spent on the Pin Array. These measurements can be used to quantitatively assess acute and chronic tactile nociception and analgesic efficacy in laboratory animals.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an MCD having an array of pins and a laboratory rat as the experimental model in accordance with an embodiment of the present technology.

FIG. 2 is an exploded perspective view of the three components of the MCD device having the pin platform in the lowered configuration in accordance with an embodiment of the present technology.

FIG. 3 is a cross-sectional side view of the connection elements linking the three compartments of the MCD and the positioning of the pin array prior to mechanical testing in accordance with an embodiment of the present technology.

FIG. 4 is a cross-sectional side view of the initial configuration of the MCD when used in the initial training step without the presence of the mechanical conflict in accordance with an embodiment of the present technology.

FIG. 5 is a cross-sectional side view of the steps required for the animal to traverse the MCD without the presence of the mechanical conflict in accordance with an embodiment of the present technology.

FIG. 6 is a cross-sectional side view of the animal traversing the MCD in the presence of the mechanical conflict in accordance with an embodiment of the present technology.

FIG. 7 is a plan view of a portion of an MCD depicting an animal paw traversing over an alley floor and pins in accordance with an embodiment of the present technology.

FIG. 8 graphically depicts probe height versus time, showing that latency of an animal to exit the light chamber increases as a function of probe height.

FIG. 9 graphically depicts probe height versus time, showing that time spent on the stimulus array decreases as function of probe height in rats with persistent neuropathic pain induced by a chronic constriction injury (CCI) of the left sciatic nerve, but not in control rats.

FIG. 10 graphically depicts probe height versus time, showing that latency to exit remains consistent between the first and last trials irrespective of stimulus intensity.

FIG. 11 graphically depicts probe height versus time, showing that time spent on the stimulus array remains consistent between the first and last trials irrespective of stimulus intensity.

FIG. 12 graphically depicts the time to exit for rats receiving various treatments, where latency to exit in CCI rats is modulated by pregabalin (PG).

FIG. 13 graphically depicts the time spent on the stimulus array for rats receiving various treatments, where time spent on the stimulus array is not modulated by pregabalin (PG) in CCI rats.

FIG. 14 graphically depicts the time to exit for rats receiving various treatments, where the increased latency to exit produced by formalin injection (0.2%, s.c.) into one hindpaw was not reduced by systemic morphine (MRP, 2.5 mg/kg i.p.).

FIG. 15 graphically depicts the time spent on the stimulus array for rats receiving various treatments, where increased time spent on the stimulus array produced by formalin injection (0.2%, s.c.) into one hindpaw was attenuated by systemic morphine (MRP, 2.5 mg/kg i.p.).

Corresponding reference numerals indicate corresponding parts throughout the several views of the drawings.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. A non-limiting discussion of terms and phrases intended to aid understanding of the present technology is provided at the end of this Detailed Description.

The present technology relates to apparatus, systems, and methods including a mechanical conflict device (MCD). Measures of innate reflexes remain the cornerstone of preclinical pain research, primarily due to their technical simplicity and efficiency. However, reflex measures are flawed because they fail to adequately represent the clinical experience of pain, which is composed of sensory, affective and motivational, and cognitive components. Furthermore, reflex tests are neither sensitive nor specific predictors of drug efficacy in clinical trials. The widespread adoption of paradigms that measure spontaneous and/or complex pain behaviors that require suraspinal processing has been argued for by many pain researchers. To this end, the present apparatus, systems, and methods were developed and validated using a motivational choice or conflict pain assessment device, termed the mechanical conflict device (MCD).

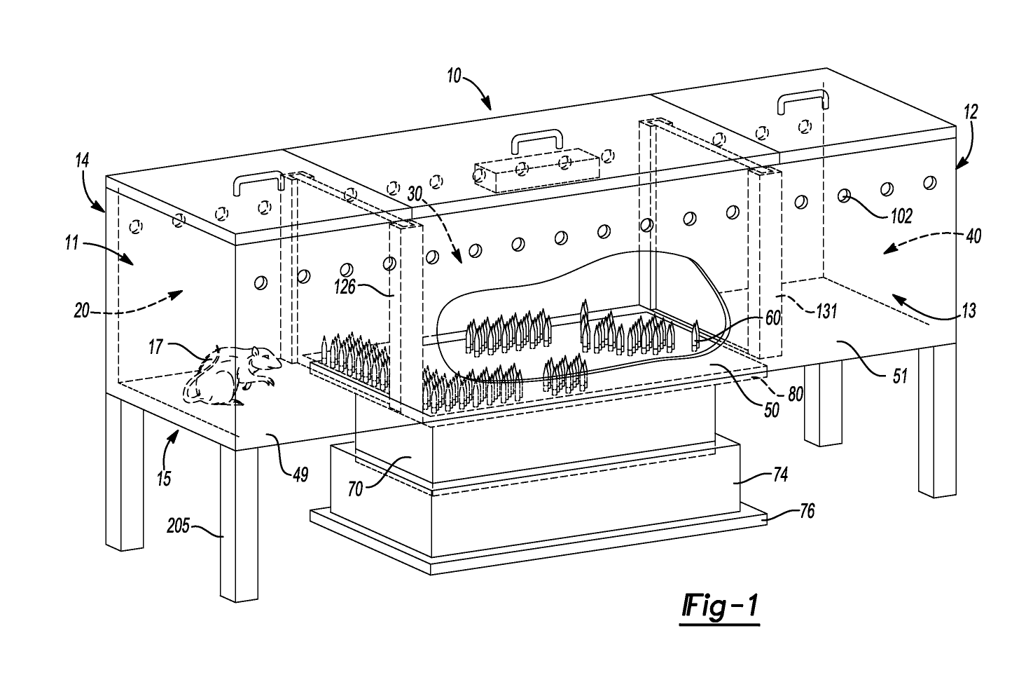

Example embodiments will now be described more fully with reference to the accompanying drawings. With particular reference to FIGS. 1, 2, and 3, an embodiment of a mechanical conflict device (MCD) 10 constructed in accordance with the present technology is shown. The MCD 10 can comprise an enclosure, such as a rectangular-shaped enclosure, generally having three enclosures or compartments therein, as indicated by dashed arrows 20, 30, and 40. The shape of the enclosure is exemplified as a rectangle; however, other shapes comprising the same or similar sections or enclosures are also within the scope of the technology. The first compartment can include a holding compartment 20 connected to an alley compartment 30. Alley compartment 30 is also connected to a third compartment, a compensatory compartment 40.

In some embodiments, the MCD 10 can be made of any durable, washable or sterilizable, solid material, including, plastic, glass, and can generally be any translucent or semi-translucent material. Preferably, the MCD is completely made from light weight Perspex® acrylic plastic, ranging in thickness from about 5 mm to about 20 mm.

In some embodiments, the MCD 10 can include two end walls 11 and 12 connected to two side walls 13 and 14 and have a floor 15 connected thereto. The various walls 11, 12, 13 and 14 can be 100 percent transparent or can alternatively be tinted, but nevertheless mildly translucent to enable visual detection of the movement of a laboratory animal 17, as illustrated by a laboratory rat in the figures. In some embodiments, the walls 11, 12, 13 and 14 can include red plastic which permits visual monitoring of the animal, but not vice versa. In some embodiments, the laboratory animal 17 (e.g., a rat) cannot see red; therefore, the walls of the MCD 10 appear black to the animal. The various walls 11, 12, 13 and 14 can have a thickness ranging from 5 mm to about 20 mm.

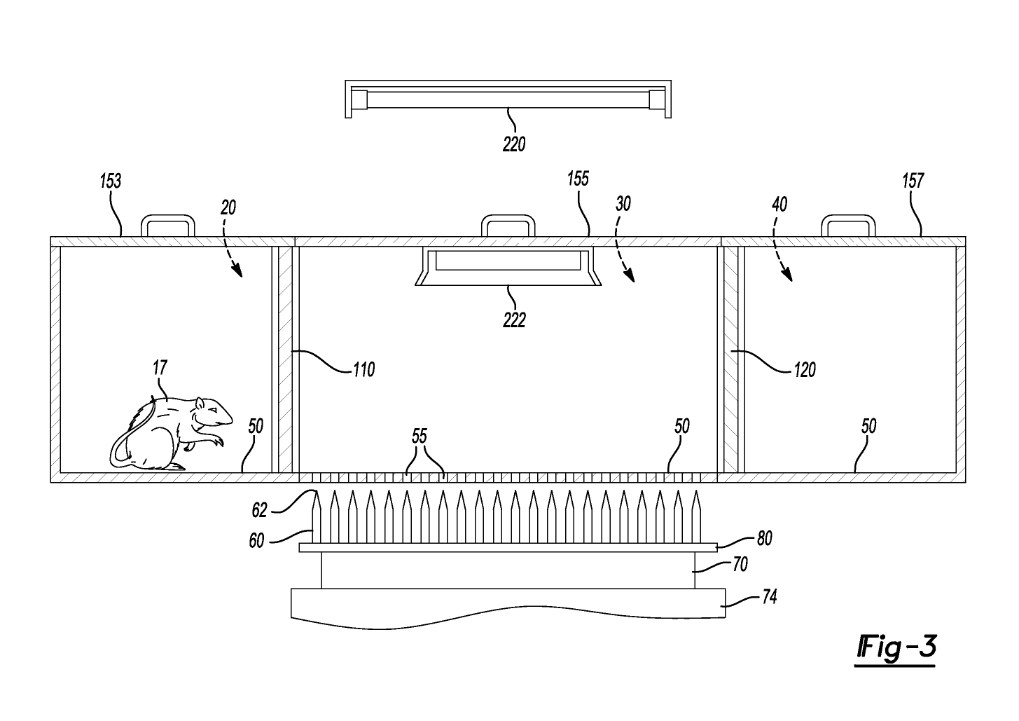

In some embodiments, the MCD 10 further comprises a means for providing greater illumination of the holding compartment 20 or the holding compartment 20 and the alley compartment 30 with respect to illumination of the compensatory compartment 40. This can be accomplished in various ways. For example, lighting (such as light source 220 in FIGS. 3-6) can be positioned in the MCD 10 to increase illumination of the holding compartment 20 or to increase illumination of the holding compartment 20 and the alley compartment 30 with respect to illumination of the compensatory compartment 40. In addition, anywhere from a portion of the compensatory compartment 40 to the whole compartment can comprise an opaque or tinted, transparent material to reduce and/or eliminate light from entering the compensatory compartment 40. A cover or lid 157 that blocks light from entering the compensatory compartment may also be used.

In some embodiments, the MCD 10 can comprise two compartments (e.g., measuring about 16.5 cm×21.5 cm×15.25 cm each), such as the holding 20 and compensatory compartments 40 connected by a third compartment comprising an enclosed alley (e.g., measuring about 39.5 cm×21.5 cm×15.25 cm), such as the alley compartment 30. The dimensions of the MCD 10 are not critical; measurements can be adjusted to accommodate the type of test being conducted, i.e., one animal or multiple animals being tested at the same time; or the size and/or type of laboratory animal being tested; e.g., rabbits versus mice.

In some embodiments, side walls 13 and 14 have ventilation holes 102 to enable ventilation of the interior of the MCD 10. In some embodiments, each of the walls 11, 12, 13 and 14 can independently have no holes, one hole, or a plurality of holes 102.

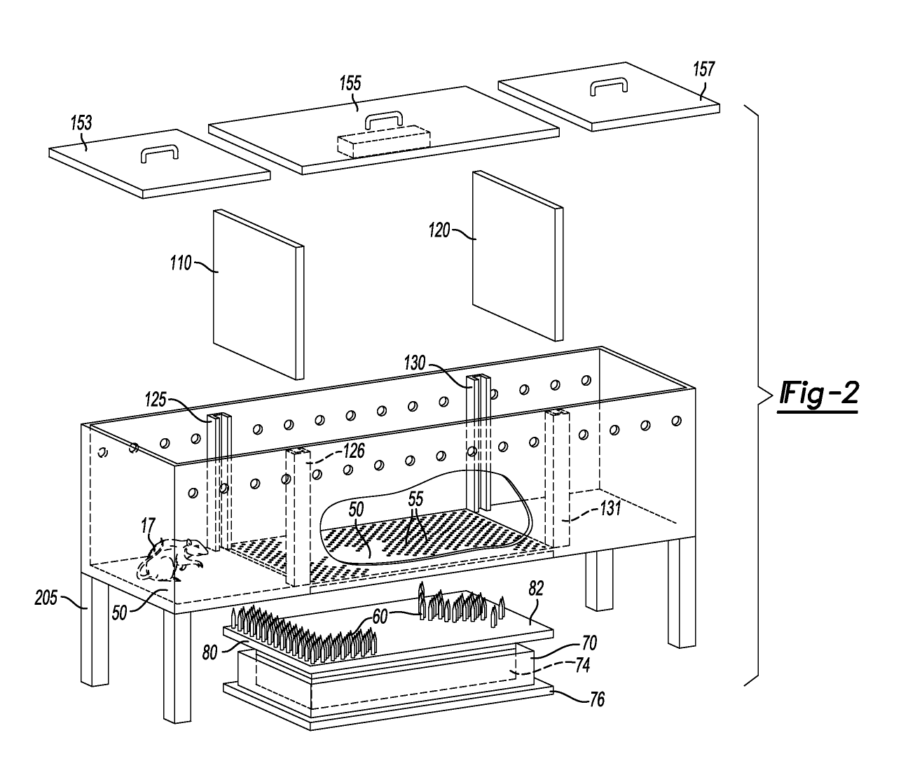

Separating compartments 20, 30, and 40 are panel walls 110 and 120. Panel walls 110 and 120 are best shown in FIG. 2 and can be made from generally the same washable or sterilizable materials used for manufacturing end walls 11 and 12 and side walls 13 and 14. Panel walls 110 and 120 can be slidingly engageable with one or more securing means 125, 126, 130, and 131 which are placed between holding compartment 20 and alley compartment 30 and between the compensatory compartment 40 and alley compartment 30. The securing means 125, 126, 130, and 131 can be made from any solid material and shaped to accommodate the sliding panel walls 110 and 120. Typically, when panel walls 110 and 120 are placed within securing means 125, 126, 130, and 131, the panel walls 110 and 120 are in contact or proximate to floor surfaces 49 and 51 respectively, prohibiting the passage of the laboratory animal 17 between the compartments 20, 30 and 40. Holding compartment 20 can have a floor surface 49, the alley compartment 30 can have an alley floor 50, and the compensatory compartment 40 can have a floor surface 51.

In some embodiments, holding compartment 20, alley compartment 30, and compensatory compartment 40 each have a removable lid 153, 155, and 157, respectively. Lids 153, 155 and 157 may be made from the same material as used in sliding walls 110 and 120; e.g., plastic or glass. Preferably lids 153, 155 and 157 are all made from light weight Perspex® acrylic plastic, ranging in thickness from about 5 mm to about 20 mm. In some embodiments, lids 153 and 155 are transparent while lid 157 can be tinted but somewhat translucent. Lids 153, 155, and 157 can also optionally have lid handles 154, 156, and 158, respectively, for easy attachment and removal.

Referring now generally to FIGS. 1 and 2, as shown in an exploded view, the middle alley compartment 30 has an alley floor 50 that can include an array or plurality of perforations 55 that traverse the entire thickness of floor 50. The perforations 55 permit the passage of one or more pins 60 on pin platform 80. The pin platform surface 82 can have the pins 60 arranged in a particular geometric orientation or spatial arrangement operable to make it impossible for the laboratory animal 17 to cross the alley floor 50 in the alley compartment 30 without at least one or more paws or limbs making contact with the pins 60. For example, the pins 60 may be arranged such that two of the animal's 17 paws are in contact with the pins 60 at any one point when the animal 17 traverses the alley compartment 30, where the pin arrangement may be dependent on the animal's 17 gait and paw size.

The MCD 10 further includes a noxious mechanical stimulus as exemplified by an array of pins 60 embedded or disposed on pin platform 80. Pin platform 80 can be mounted to an elevation mechanism, illustratively shown as moveable platform structures 70, 74, and 76. Generally, the elevation mechanism can include any form of mechanical and/or electrical actuation to raise and lower pin platform 80 and thereby raise and/or lower pins 60 through perforations 55 in alley floor 50 as illustratively shown in FIGS. 1, 5, and 6. In some embodiments, the pins 60 when mounted onto pin platform surface 82 are operable to be raised in 0.01 mm or greater increments above the alley floor 50, to a maximum height of about 1 to about 20 mm, preferably from about 1 mm to about 5 mm above the surface of alley floor 50.

In other embodiments, the MCD 10 may comprise other types of noxious stimuli in place of or in addition to the noxious mechanical stimulus in the alley compartment 30. Examples of other noxious stimuli include an aversive thermal stimulus, aversive odor, aversive sound, and aversive texture. Aversive thermal stimuli include heated or cooled surfaces or surface portions that the animal 17 finds aversive to contact, where the heated or cooled surfaces can be on the alley floor 50. Aversive odors or sounds can be present or introduced or initiated within the alley compartment 30 when the animal 17 enters the alley compartment 30. Textures that the animal 17 finds aversive include those with jagged or pointed projections and those with edges or points that localize contact of the animal's 17 weight to just a portion of the limb or paw, thereby increasing pressure to that location versus the typical contact of the limb or paw spread out over a flat surface.

In some embodiments, the array or plurality of perforations 55 accommodates an adjustable array of one or more probes (e.g., metal or plastic tapered pins) as the array of pins 60. The probes can be located below the floor 50 of the alley that separates two compartments. For example, the adjustable array may include a number of probes having a spacing appropriate for a particular animal size. Configuration of the probes can be based on variables such as the size of an animal's paw, gait type, and/or stride length, among others. In this manner, the MCD can be used with various pin platforms 80 having various types and spacing of pins 60 that are suitable for various laboratory animals 17.

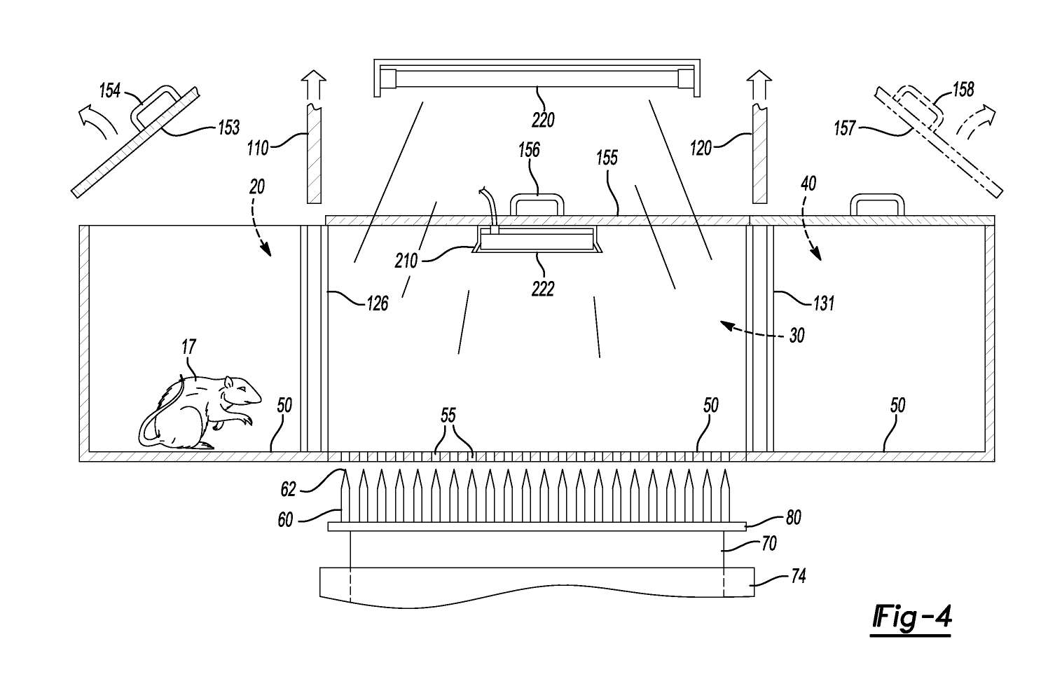

Referring now to FIGS. 4, 5, and 6, in some embodiments the pins 60 can have a pin apex 62 and a pin body 60. The pins 60 can be made from any resilient, washable or sterilizable material that can be embedded into or otherwise attached to a pin platform surface 82. In some embodiments, pins 60 can be manufactured from metals, for example, surgical stainless steel, stainless steel, iron, titanium, alloys thereof and the like. Pins 60 can also be manufactured from any sturdy plastics, for example, polycarbonates, polyaryletheretherketone (PEEK), polypropylene, polyvinyl chloride and any other semicrystalline thermoplastic materials with excellent mechanical and chemical resistance properties that will not deform upon loading with a laboratory animal. In some embodiments, the pins 60 are removable and can be repositioned to reconfigure the array of pins 60 on the pin platform 80.

Pins 60 are illustratively shown with a pointed pin apex 62. However, other pin apex 62 configurations are included within the scope of the present technology, including, flat and round pin apex 62 configurations (not shown). Although pin apex 62 is illustrated in the figures to be pointed, the pins 60 can be configured to not be so sharp as to be capable of puncturing or damaging the skin or paws 16 of the laboratory animal 17. In some embodiments, pin platform 80 can also include an array of blunt pins 60 (not shown) that may be interchangeable with pin platform 80 having pointed pins 60 as illustratively shown in the figures.

The second compartment adjoining the alley compartment 30 is the compensatory compartment 40. In some embodiments, the portion of the side walls 13 and 14 that form the compensatory compartment 40 along with end wall 12 can be tinted relative to the other two compartments 20 and 30 making the interior of the compensatory compartment 40 dark, specifically, if the aversive stimulus in the holding compartment and/or the alley compartment 30 used is light. In some embodiments, with reference to FIG. 2, lids 153 and 155 may be transparent, whereas lid 157 may be tinted to limit or reduce the amount of light entering into the compensatory compartment 40 relative to the holding compartment 20 and the alley compartment 30. In some embodiments, when the holding compartment 20 and/or the alley compartment 30 are lit, a darkened compensatory compartment 40 provides a positive stimulus, negative reinforcement, or compensation to the laboratory animal 17 to traverse the alley compartment 30 having pins 60 raised through the perforations 55 in alley floor 50 into the compensatory compartment 40.

The compensatory compartment 40 can be a compartment of the MCD 10 that is darkened, and/or can contain an item of gratification such as a food, a liquid, a drug, for example, a narcotic or some other pleasurable item for the laboratory animal 17. The compensatory compartment 40 need not be dark; for example, if the reward or positive stimulus for the laboratory animal to enter the compensatory compartment 40 is a food or drug substance that induced the laboratory animal to traverse over the noxious mechanical stimuli, for example, the pins 60, to get into the compensatory compartment 40.

While the illustrative figures have shown the MCD 10 having four legs 205, these are drawn purely for illustration to show that the pin platform 80 mounted on the elevation means, illustratively shown as platform structures 70, 74, and 76 resides below the alley floor 50. While legs 205 are not critical, one of ordinary skill can envision other ways of elevating the pins 60 through the perforations 55 in the alley floor 50 without the need to have legs 205.

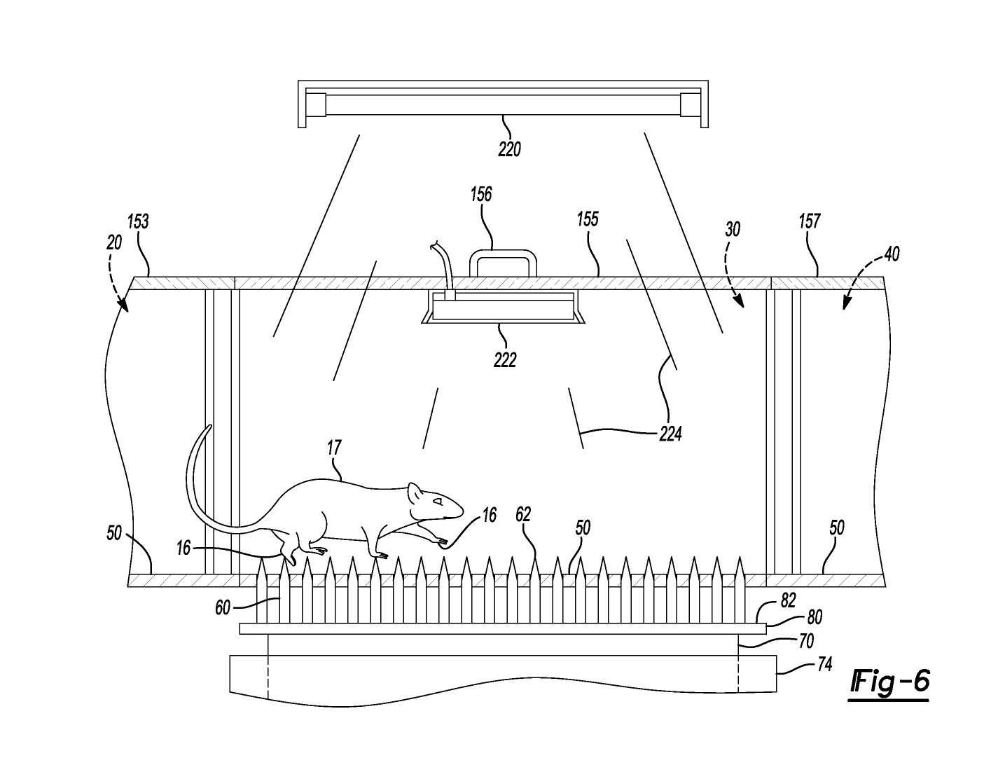

The mechanical conflict device can be used in various methods. With reference now to FIGS. 3-7, the MCD 10 of the present technology can be used to measure the response of a laboratory animal 17, such as a rat, to noxious mechanical stimuli. In this test, exit or escape from an aversive environment to a preferred environment is deterred by a noxious mechanical stimulus represented by the pins 60 on a raised pin platform 80, as shown in FIG. 6. In an initial MCD 10 training period, the pins 60 are lowered below the alley floor 50 and the laboratory animal 17 is placed into the holding compartment 20. The holding compartment 20 can be lit to provide an aversive environment; for example, the animal 17 can be a rat which is generally averse to light. The holding compartment 20 and the alley compartment 30 can be illuminated with normal room lighting. In some embodiments, the holding compartment 20 and/or the alley compartment 30 are supplemented by a light source 220, for example, a high-intensity, white-light LED array positioned above the alley compartment 30, as shown in FIGS. 3-6. At that time, panel walls 110 and 120 can be raised to allow the laboratory animal 17 to learn that it can exit from the mildly aversive stimuli (the light 220) in the holding compartment 20 and alley compartment 30 and move across the floor 50, passing into the more comfortable compensatory compartment 40 where it is generally dim and provides the laboratory animal 17 with a generally more rewarding area. Because some laboratory animals, for example a laboratory rat, are nocturnal and naturally avoid light, the light shone from light source 220 in these compartments acts as a mildly aversive stimulus. Once the laboratory animal 17 has “learned” how to escape from the mildly aversive environment caused by the lit holding compartment 20, the application of the noxious mechanical stimuli represented by pins 60 can begin.

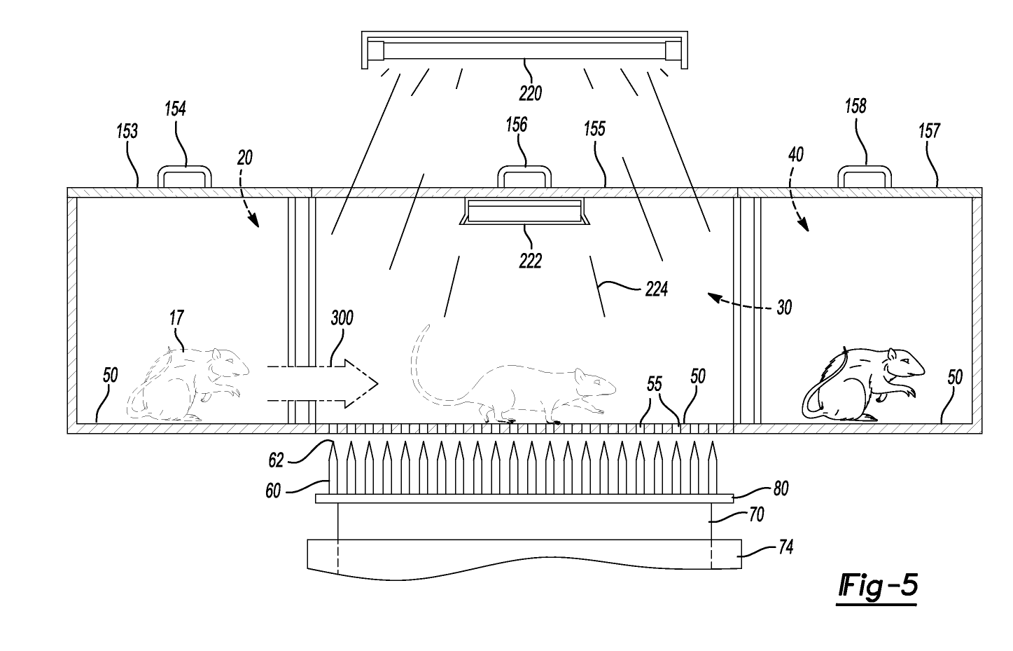

With reference to FIGS. 3-7, laboratory animal 17 is nocturnal and naturally avoids light (e.g., a rat); the light in these areas acts as a mildly aversive stimulus. The compensatory compartment 40 is dark and therefore preferred by the laboratory animal 17. Laboratory animal 17 has learned to escape the light in the holding compartment 20 by crossing the alley compartment 30 to the preferred compensatory compartment 40 as shown in FIG. 5.

Although light is used as an example of an aversive stimulus, such as light source 220, other stimuli can be introduced into the holding compartment 20 and/or the alley compartment 30 so that the animal has an incentive or desire to leave the holding compartment 20, traverse the alley compartment 30, and reach the compensatory compartment 40. The compensatory compartment 40, for example, may lack the stimulus or have a reduced level of one or more aversive stimuli. Examples of stimuli that may be used in addition to or in place of light include odors, sounds, changes in texture or coating of floor surfaces 49, 50 of the holding and alley compartments 20, 30 versus the compensatory compartment 40 floor surface 51. Conversely, the compensatory compartment 40 may include a desirable stimulus or positive reinforcement that provides an incentive for the animal 17 to leave the holding compartment 20, traverse the alley compartment 30, and reach the compensatory compartment 40. In some embodiments, there may be a combination of an aversive stimulus in the holding and/or alley compartments 20, 30 and a desirable stimulus or positive reinforcement in the compensatory compartment 40. Examples of desirable stimuli or positive reinforcers include food, bedding, and desirable odors or sounds to the animal, among others.

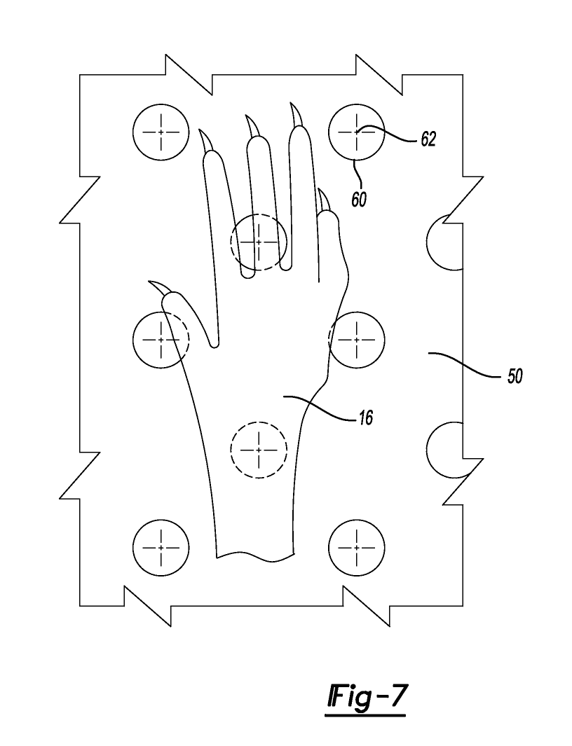

Following training, a mechanical “conflict” is presented by elevating the pins 60 above the alley floor 50 by raising platforms 70, 74, and 76 to enable pins 60 on pin platform 80 to pass through perforations 55 and alley floor 50. In some cases, the pins 60 can be raised by increments of at least 0.01 mm increments. As illustratively shown in FIG. 7, the laboratory animal 17 traverses over the pins 60 wherein at least two paws 16 can be in contact with a pin apex 62 as the laboratory animal 17 crosses the alley compartment 30. The laboratory animal 17 must choose whether or not gaining access to the compensatory compartment 40 is worth enduring the pain of crossing the pins 60, which is somewhat analogous to an animal's natural environment where painful mechanical stimuli like thorns, claws, teeth, and spines may impede access to food, shelter, and/or safety. Thus, the laboratory animal 17, not the investigator, chooses whether or not it will experience a noxious event.

Pain can be assessed by measuring at least three variables, including: 1) Latency to Exit Light Chamber, 2) Latency to Enter Dark Chamber, and 3) Duration of Initial Cross or Total Time Spent on the Pin Array. In some embodiments, the movement of the laboratory animal 17 through the MCD 10 can be monitored visually; for example, by manually timing the movement of the laboratory animal 17, measuring one or more of the three variables discussed above, or the MCD 10 can be fitted with a camera (illustratively shown as module 222) operably connected to a timer (not shown) to record the movements of laboratory animal 17 through the MCD 10. The recorded images can then be analyzed to determine 1) Latency to Exit Light Chamber, 2) Latency to Enter Dark Chamber, and 3) Duration of Initial Cross. In some embodiments, one or more sensors (not shown), which can also be part of module 222, can also be placed throughout the walls 11, 12, 13 and 14 or floor 50 of the MCD 10 to automatically detect movement and timing of such movements by laboratory animal 17 and such data fed into a processor, including for example, a microprocessor in a suitably programmed computer to determine 1) Latency to Exit Light Chamber, 2) Latency to Enter Dark Chamber, and 3) Duration of Initial Cross. In some embodiments, additional variables can also be measured. For example, the methods of the present technology can measure latency and duration of second cross; total number of crosses during an extended observation period (e.g., 5 min); and frequency of completed crosses (as opposed to failed crosses in which the animal turns back to the lit chamber before having reach the dark chamber).

The MCD 10 can be used to analyze the efficacy and specificity of a test compound; for example, an analgesic drug that may ameliorate chronic neuropathic pain. The present MCD 10 can be used to reliably and accurately measure nociception in preclinical studies using conventional pain testing laboratory animals. The MCD 10 enables determination of qualitative and quantitative aspects of pain and other physiological processes (e.g., drug addiction) that have not previously been measurable using reflexive specific pain assessment devices of the past. Past pain assessment devices rely on pain reflexes which do not reflect the complex interaction between learned experiences and environmental and physiological factors that often shape reactions to painful events. Reflexes are readily altered by disease- and drug-induced deficits in motor function. As measures of acute pain, reflex tests are also inadequate for the study of persistent pain states. They fail to distinguish acute from persistent pain states in animal models and remain poor predictors of analgesic drug efficacy in humans with chronic pain conditions. The present MCD 10 and methods of use therewith enable preclinical pain research in animal models and incorporate measures of pain that require brain processing and reflect the array of complex behaviors associated with acute and chronic nociception.

In some embodiments, the present devices, apparatus, and systems can be used in various methods for assessing acute and chronic nociception. In some embodiments, the MCD comprises two compartments connected by an enclosed alley. One compartment is brightly illuminated with a series of LED lights and the other compartment is dark. An adjustable array of probes (metal or plastic tapered pins) is located below the floor of the alley that separates the two compartments; e.g., an array of about 500 pins.

Probes are positioned below the alley floor and the animals are placed into a lit holding compartment. Animals reliably learn to escape an aversive light stimulus by crossing the alley to the preferred dark compartment in about three sessions conducted over about three consecutive days.

In some embodiments, the method includes the following testing procedure. During testing, escape from the light was impeded by elevating the pins about 0.5 mm to about 4 mm above the alley floor. As such, animals experience a cognitive conflict in that the motivational drive to acquire a reward (escape to darkness) was pitted against the negative consequence of experiencing pain.

In some embodiments, the method includes the dependent variables: 1) Latency to Exit Light Chamber and 2) Total Time Spent on the Probe Array. These variables can be manually measured by an investigator or by using an automated camera or motion detecting system, for example.

In some embodiments, one or more animals are subjected to an experimental pain model, where the experimental pain model comprises neuropathic pain resulting from a chronic constriction injury (CCI) produced by ligation of the common sciatic nerve on the left side of the animal. In some embodiments, the experimental pain model comprises inflammatory pain produced by low-dose formalin injection into the dorsum of the left hindpaw of the animal.

In some embodiments, variable treatments include the following drugs: Vehicle: saline; Pregabalin: 10 and 30 mg/kg, i.p.; and Morphine Sulfate: 2.5 mg/kg, i.p.

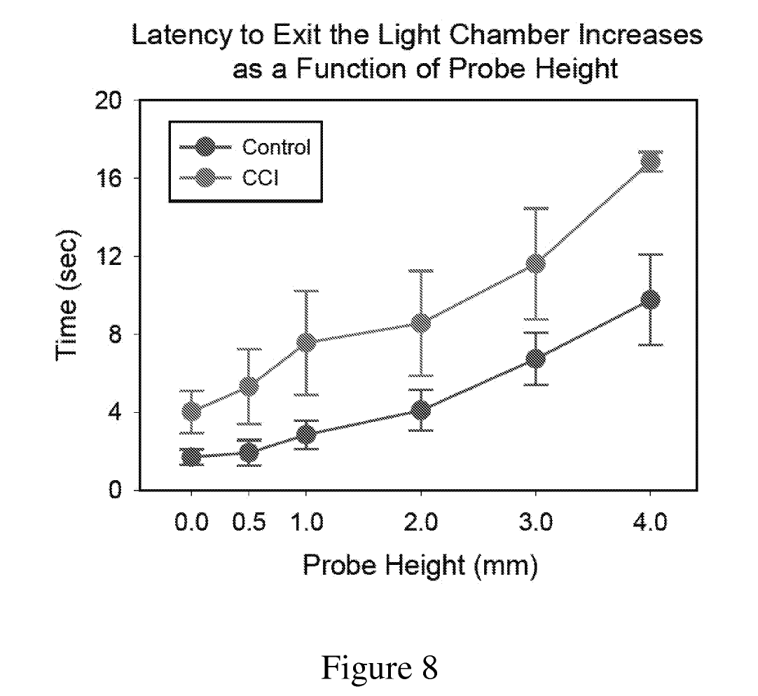

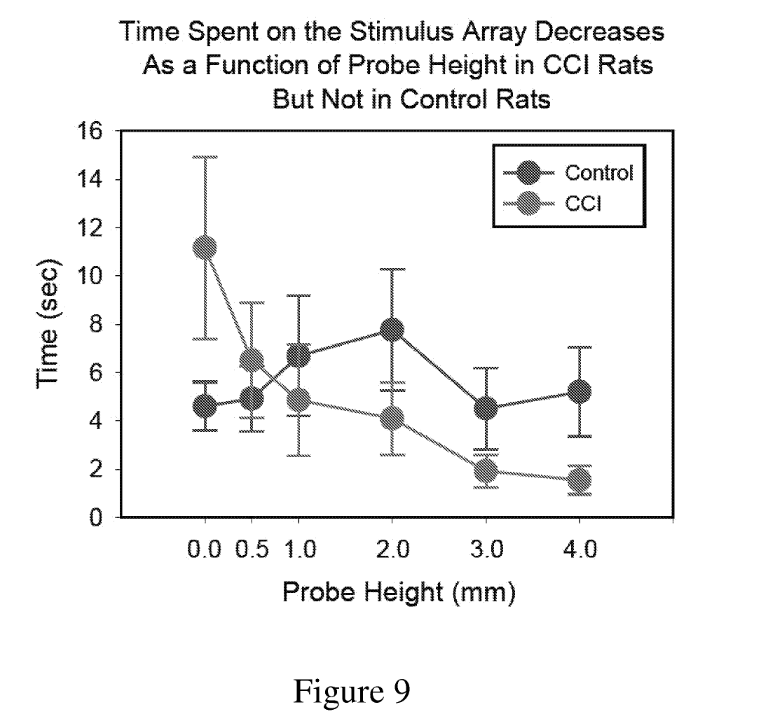

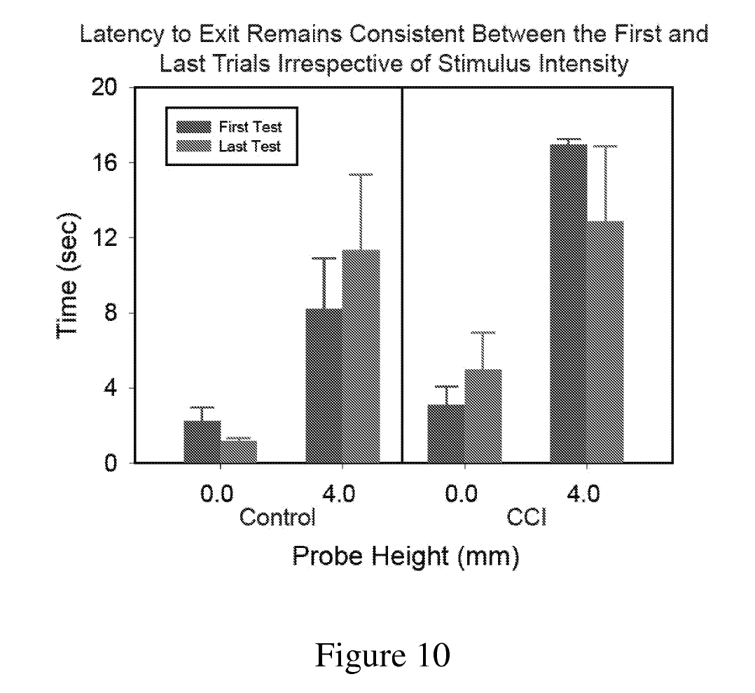

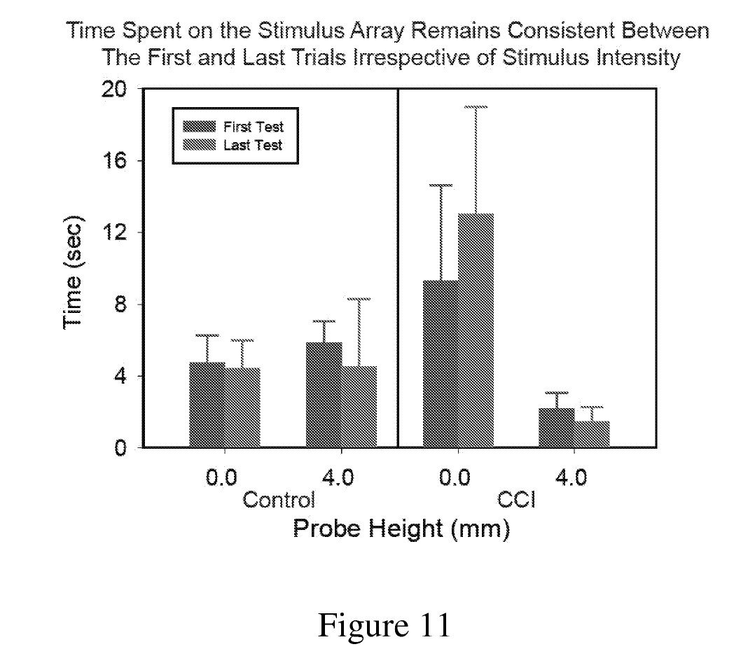

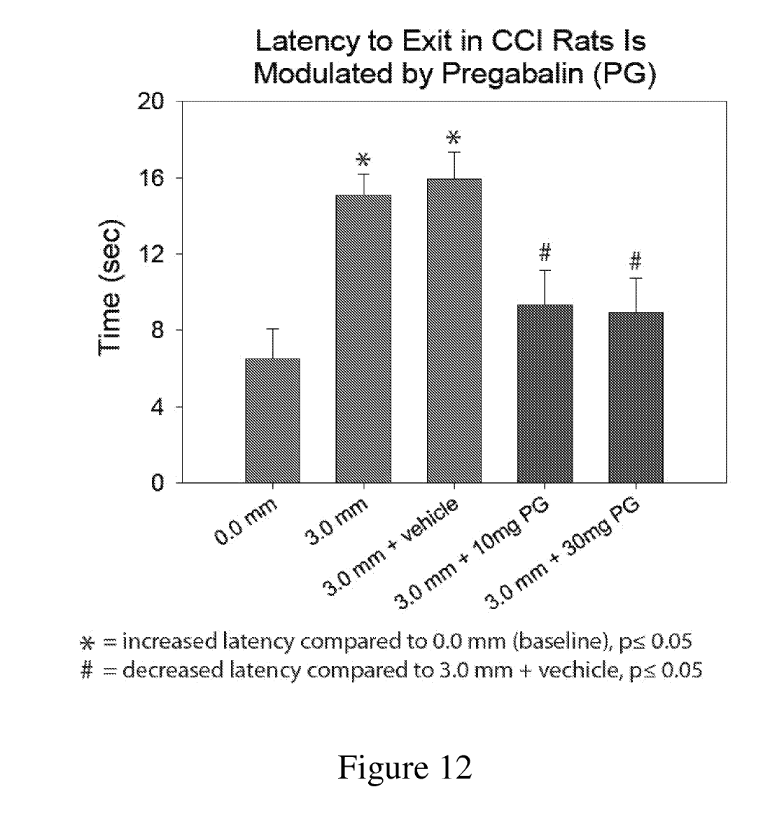

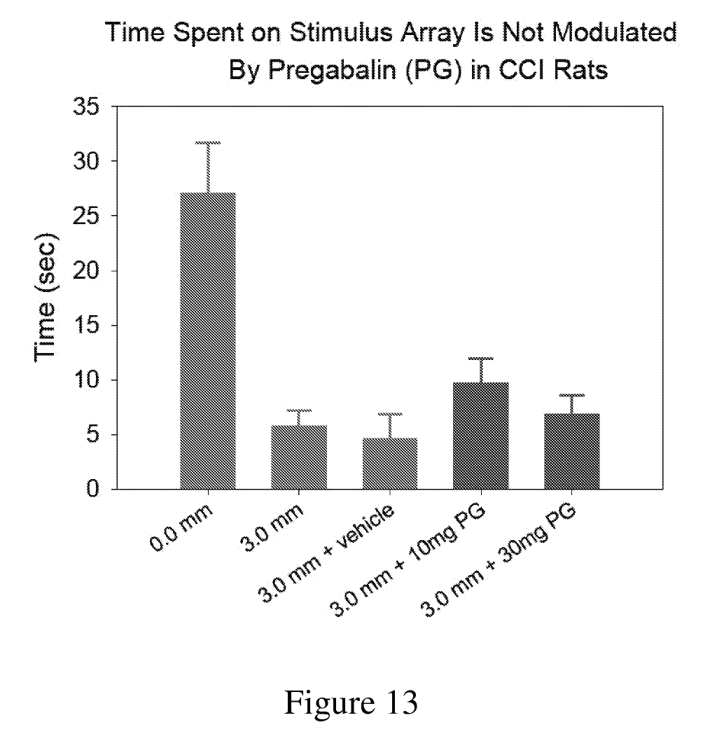

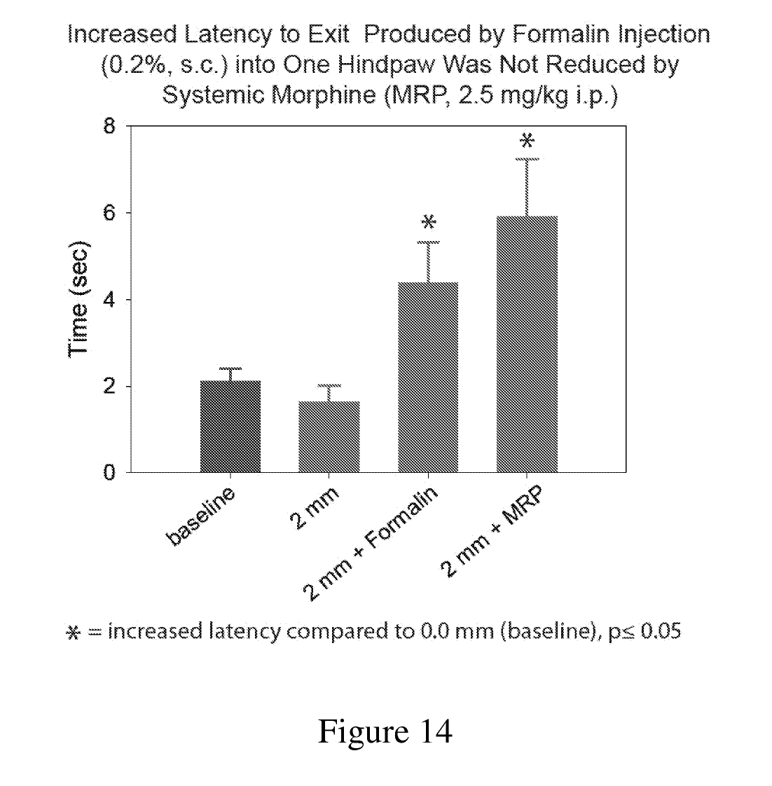

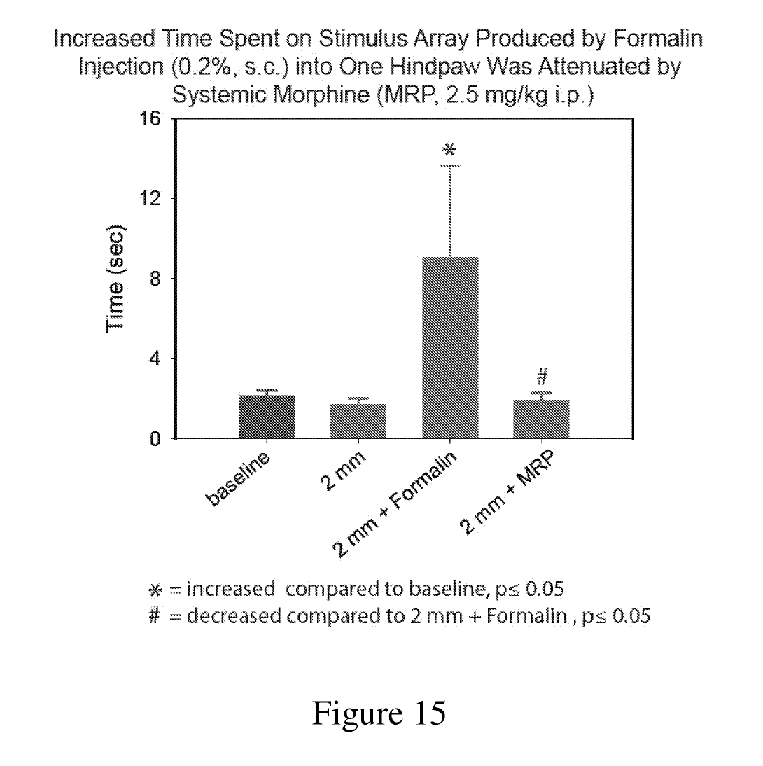

In reference to FIGS. 8 through 15, the following results were obtained using an MCD according to the present methods. As shown in FIG. 8, the latency of an animal to exit the light chamber increases as a function of probe height. FIG. 9 demonstrates that the time spent on the stimulus array by the animal decreases as function of probe height in CCI rats but not in control rats. As shown by FIG. 10, the latency to exit for the animal remains consistent between the first and last trials irrespective of stimulus intensity. FIG. 11 illustrates that time spent on the stimulus array remains consistent between the first and last trials irrespective of stimulus intensity. Latency to exit in CCI rats is modulated by pregabalin (PG), as depicted in FIG. 12. The time spent on the stimulus array for rats receiving various treatments, as shown in FIG. 13, demonstrates that time spent on the stimulus array is not modulated by pregabalin (PG) in CCI rats. FIG. 14 illustrates the time to exit for rats receiving various treatments, where the increased latency to exit produced by formalin injection (0.2%, s.c.) into one hindpaw was not reduced by systemic morphine (MRP, 2.5 mg/kg i.p.). Finally, as shown in FIG. 15, the time spent on the stimulus array for rats receiving various treatments shows that the increased time spent on the stimulus array produced by formalin injection (0.2%, s.c.) into one hindpaw was attenuated by systemic morphine (MRP, 2.5 mg/kg i.p.).

Accordingly, the present apparatus, systems, and methods show that the MCD possesses the characteristics of a valid and reliable pain measure, where:

1) MCD behaviors differentiate acute and chronic pain, and change as a function of stimulus intensity (e.g., FIGS. 8 and 9).

2) MCD testing is repeatable. The nociceptive probes do not cause tissue damage and there is no evidence of learning or testing effects (e.g., FIGS. 10 and 11).

3) MCD behaviors differentiate neuropathic and inflammatory pain models and are sensitive to analgesic treatment (e.g., FIGS. 12 to 15).

The present technology further includes the following apparatus, device, system, and method embodiments.

A first embodiment includes a mechanical conflict device (MCD) operable to assess a physiologic experience in an animal, the device comprising: an enclosure comprising: a holding compartment; a compensatory compartment; and an alley compartment connecting the holding compartment to the compensatory compartment, the alley compartment having a plurality of perforations disposed on a floor; and a noxious mechanical stimulus comprising a platform, a plurality of pins disposed on the platform, and a platform raising means to raise the plurality of pins through the plurality of perforations in the floor of the alley compartment.

A second embodiment includes the first embodiment wherein the enclosure comprises a housing having a floor connected to a plurality of walls.

A third embodiment includes the first embodiment wherein the enclosure comprises a transparent material.

A fourth embodiment includes the first embodiment wherein at least a portion of the enclosure comprises a tinted, transparent material.

A fifth embodiment includes the first embodiment further comprising a means for providing greater illumination of the holding compartment or the holding compartment and the alley compartment with respect to illumination of the compensatory compartment.

A sixth embodiment includes the fifth embodiment wherein the means for providing greater illumination of the holding compartment or the holding compartment and the alley compartment comprises one or more of: lighting positioned to increase illumination of the holding compartment or to increase illumination of the holding compartment and the alley compartment with respect to illumination of the compensatory compartment; at least a portion of the compensatory compartment comprising an opaque or tinted, transparent material; and a cover or lid that blocks light from entering the compensatory compartment.

A seventh embodiment includes the first embodiment wherein the enclosure includes at least one ventilation hole.

An eighth embodiment includes the first embodiment further comprising panel walls separating the holding compartment and the compensatory compartment from the alley compartment, the panel walls independently moveable to open or close access between the respective compartments.

A ninth embodiment includes the eighth embodiment wherein the panel walls are slidingly engageable with one or more securing means placed between the holding compartment and the alley compartment and placed between the compensatory compartment and alley compartment.

A tenth embodiment includes the first embodiment wherein the holding compartment, alley compartment, and compensatory compartment each have a removable lid.

An eleventh embodiment includes the first embodiment wherein the plurality of pins are arranged on the platform so that a laboratory animal cannot traverse the alley compartment floor when the pins are disposed through the perforations without at least one limb making contact with one pin.

A twelfth embodiment includes the first embodiment wherein the means of raising the platform can incrementally vary the extent of the pins disposed through the perforations.

A thirteenth embodiment includes the first embodiment wherein the compensatory compartment comprises a positive stimulus to an animal.

A fourteenth embodiment includes the thirteenth embodiment wherein the positive stimulus comprises reduced illumination with respect to the holding compartment, food, a drug, or a desirable odor or sound.

A fifteenth embodiment includes the first embodiment wherein the holding compartment comprises an aversive stimulus to an animal.

A sixteenth embodiment includes the fifteenth embodiment wherein the aversive stimulus comprises increased illumination with respect to the compensatory compartment, or an aversive odor or sound.

A seventeenth embodiment includes the first embodiment wherein: the enclosure comprises a tinted, transparent material; the enclosure further comprises: a plurality of ventilation holes; and panel walls separating the holding compartment and the compensatory compartment from the alley compartment, the panel walls independently moveable to open or close access between the respective compartments; and further comprising lighting operable to increase illumination of the holding compartment with respect to illumination of the compensatory compartment.

An eighteenth embodiment includes a method of measuring nociception in a laboratory animal, the method comprising: providing a MCD according to the first embodiment; raising the plurality of pins through the plurality of perforations in the floor of the alley compartment; placing an animal in the holding compartment; measuring at least one of: latency of the animal to exit the holding compartment; latency of the animal to enter the compensatory compartment; and duration of the initial cross of the alley compartment by the animal or the total time the animal spent on the pins.

A nineteenth embodiment includes the eighteenth embodiment wherein the MCD further comprises lighting positioned to increase illumination of the holding compartment or to increase illumination of the holding compartment and the alley compartment with respect to illumination of the compensatory compartment.

A twentieth embodiment includes the nineteenth embodiment wherein the animal is conditioned to the MCD by a conditioning method comprising: placing the animal in the holding compartment without raising the plurality of pins through the plurality of perforations in the floor of the alley compartment and allowing the animal to exit the holding compartment, traverse the alley compartment, and enter the compensatory compartment.

A twenty-first embodiment includes the twentieth embodiment wherein the conditioning method is repeated about three times for about three consecutive days.

A twenty-second embodiment includes the nineteenth embodiment wherein: the MCD further comprises panel walls separating the holding compartment and the compensatory compartment from the alley compartment, the panel walls independently moveable to open or close access between the respective compartments; and wherein the method further comprises: placing the animal in the holding compartment with the panel wall separating the holding compartment and the alley compartment positioned to close access between the compartments; and moving the panel wall separating the holding compartment and the alley compartment to a position to open access between the holding compartment and the alley compartment, wherein the panel wall separating the compensatory compartment and the alley compartment is positioned to open access between the compensatory compartment and the alley compartment.

A twenty-third embodiment includes the eighteenth embodiment wherein the compensatory compartment of the MCD further comprises a positive stimulus to the animal.

A twenty-fourth embodiment includes the twenty-third embodiment wherein the positive stimulus comprises reduced illumination with respect to the holding compartment, food, a drug, or a desirable odor or sound.

A twenty-fifth embodiment includes the twenty-third embodiment wherein the animal is conditioned to the MCD by a conditioning method comprising: placing the animal in the holding compartment without raising the plurality of pins through the plurality of perforations in the floor of the alley compartment and allowing the animal to exit the holding compartment, traverse the alley compartment, and enter the compensatory compartment.

A twenty-sixth embodiment includes the twenty-fifth embodiment wherein the conditioning method is repeated about three times for about three consecutive days.

A twenty-seventh embodiment includes the eighteenth embodiment wherein the holding compartment of the MCD further comprises an aversive stimulus to the animal.

A twenty-eight embodiment includes the twenty-seventh embodiment wherein the aversive stimulus is increased illumination with respect to the compensatory compartment, or an aversive odor or sound.

A twenty-ninth embodiment includes the twenty-seventh embodiment wherein the animal is conditioned to the MCD by a conditioning method comprising: placing the animal in the holding compartment without raising the plurality of pins through the plurality of perforations in the floor of the alley compartment and allowing the animal to exit the holding compartment, traverse the alley compartment, and enter the compensatory compartment.

A thirtieth embodiment includes the twenty-ninth embodiment wherein the conditioning method is repeated about three times for about three consecutive days.

A thirty-first embodiment includes the eighteenth embodiment wherein the animal is provided with a treatment intended to alleviate pain.

A thirty-second embodiment includes the thirty-first embodiment wherein the treatment intended to alleviate pain comprises administration of an analgesic or putative analgesic.

A thirty-third embodiment includes the eighteenth embodiment wherein the animal is provided with a treatment intended to increase pain sensitivity.

A thirty-fourth embodiment includes the thirty-third embodiment wherein the treatment intended to increase pain sensitivity comprises a chronic constriction injury of a nerve or injection of a substance producing inflammation.

A thirty-fifth embodiment includes the thirty-third embodiment wherein the animal is further provided with a treatment intended to alleviate pain.

A thirty-sixth embodiment includes the thirty-fifth embodiment wherein the treatment intended to alleviate pain comprises administration of an analgesic or putative analgesic.

A thirty-seventh embodiment includes the first embodiment wherein the platform raising means can raise the pins about 1 mm to about 20 mm above the alley floor.

A thirty-eight embodiment includes a conflict device operable to assess a physiologic experience in an animal, the device comprising: an enclosure comprising: a holding compartment; a compensatory compartment; and an alley compartment connecting the holding compartment to the compensatory compartment; and a noxious stimulus comprising an aversive thermal stimulus, aversive odor, aversive sound, or aversive texture in the alley compartment.

A thirty-ninth embodiment includes the thirty-eighth embodiment further comprising actuating means to release or initiate the aversive odor or aversive sound when an animal enters the alley compartment.

A fortieth embodiment includes the thirty-eighth embodiment wherein the aversive texture comprises projections with edges or points that contact a portion of an animal's limb or paw, thereby increasing pressure to that location versus contact of the limb or paw spread out over a flat surface.

A forty-first embodiment includes the thirty-eighth embodiment wherein the enclosure comprises a housing having a floor connected to a plurality of walls.

A forty-second embodiment includes the thirty-eighth embodiment wherein the enclosure comprises a transparent material.

A forty-third embodiment include the thirty-eighth embodiment wherein at least a portion of the enclosure comprises a tinted, transparent material.

A forty-fourth embodiment includes thirty-eighth embodiment further comprising a means for providing greater illumination of the holding compartment or the holding compartment and the alley compartment with respect to illumination of the compensatory compartment.

A forty-fifth embodiment includes the forty-forth embodiment wherein the means for providing greater illumination of the holding compartment or the holding compartment and the alley compartment comprises one or more of: lighting positioned to increase illumination of the holding compartment or to increase illumination of the holding compartment and the alley compartment with respect to illumination of the compensatory compartment; at least a portion of the compensatory compartment comprising an opaque or tinted, transparent material; and a cover or lid that blocks light from entering the compensatory compartment.

A forty-sixth embodiment includes the thirty-eighth embodiment wherein the enclosure includes at least one ventilation hole.

A forty-seventh embodiment includes thirty-eighth embodiment further comprising panel walls separating the holding compartment and the compensatory compartment from the alley compartment, the panel walls independently moveable to open or close access between the respective compartments.

A forty-eighth embodiment include the forty-seventh embodiment wherein the panel walls are slidingly engageable with one or more securing means placed between the holding compartment and the alley compartment and placed between the compensatory compartment and alley compartment.

A forty-ninth embodiment includes the thirty-eighth embodiment wherein the holding compartment, alley compartment, and compensatory compartment each have a removable lid.

A fiftieth embodiment includes the thirty-eighth embodiment wherein the compensatory compartment comprises a positive stimulus to an animal.

A fifty-first embodiment includes the fiftieth embodiment wherein the positive stimulus comprises reduced illumination with respect to the holding compartment, food, a drug, or a desirable odor or sound.

A fifty-second embodiment includes the thirty-eighth embodiment wherein the holding compartment comprises an aversive stimulus to an animal.

A fifty-third embodiment include the fifty-second embodiment wherein the aversive stimulus comprises increased illumination with respect to the compensatory compartment, or an aversive odor or sound.

A fifty-fourth embodiment includes a method of measuring nociception in a laboratory animal comprising providing a conflict device according to the thirty-eighth embodiment; placing an animal in the holding compartment; measuring at least one of: latency of the animal to exit the holding compartment; latency of the animal to enter the compensatory compartment; and duration of the initial cross of the alley compartment by the animal or the total time the animal spent on the pins.

A fifty-fifth embodiment includes the fifty-fourth embodiment wherein the conflict device further comprises lighting positioned to increase illumination of the holding compartment or to increase illumination of the holding compartment and the alley compartment with respect to illumination of the compensatory compartment.

A fifty-sixth embodiment includes the fifty-fourth embodiment wherein the animal is conditioned to the conflict device by a conditioning method comprising: placing the animal in the holding compartment without the noxious stimulus in the alley compartment and allowing the animal to exit the holding compartment, traverse the alley compartment, and enter the compensatory compartment.

A fifty-seventh embodiment includes the fifty-sixth embodiment wherein the conditioning method is repeated about three times for about three consecutive days.

A fifty-eighth embodiment includes the fifty-fifth embodiment wherein: the conflict device further comprises panel walls separating the holding compartment and the compensatory compartment from the alley compartment, the panel walls independently moveable to open or close access between the respective compartments; and wherein the method further comprises: placing the animal in the holding compartment with the panel wall separating the holding compartment and the alley compartment positioned to close access between the compartments; and moving the panel wall separating the holding compartment and the alley compartment to a position to open access between the holding compartment and the alley compartment, wherein the panel wall separating the compensatory compartment and the alley compartment is positioned to open access between the compensatory compartment and the alley compartment.

The embodiments and the examples described herein are exemplary and not intended to be limiting in describing the full scope of apparatus, systems, and methods of the present technology. Equivalent changes, modifications and variations of some embodiments, materials, compositions and methods can be made within the scope of the present technology, with substantially similar results. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

In some example embodiments, well-known processes, well-known device structures, and well-known technologies are not described in detail.

Non-Limiting Discussion of Terminology

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

As used herein, the words “desire” or “desirable” refer to embodiments of the technology that afford certain benefits, under certain circumstances. However, other embodiments may also be desirable, under the same or other circumstances. Furthermore, the recitation of one or more desired embodiments does not imply that other embodiments are not useful, and is not intended to exclude other embodiments from the scope of the technology.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components or process steps, the present technology also specifically includes embodiments consisting of, or consisting essentially of, such materials, components or processes excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

1. A mechanical conflict device (MCD) operable to assess a physiologic experience in an animal, the device comprising:
an enclosure comprising:
a holding compartment;
a compensatory compartment; and
an alley compartment connecting the holding compartment to the compensatory compartment, the alley compartment having a plurality of perforations disposed on a floor; and
a noxious mechanical stimulus comprising a platform, a plurality of pins disposed on the platform, and a platform raising means to raise the plurality of pins through the plurality of perforations in the floor of the alley compartment.

2. The MCD of claim 1, wherein the enclosure comprises a housing having a floor, wherein at least a portion of the floor is connected to a wall.

3. The MCD of claim 1, wherein at least a portion of the enclosure comprises a transparent material or a tinted, transparent material.

4. (canceled)

5. The MCD of claim 1, further comprising a means for providing greater illumination of the holding compartment or the holding compartment and the alley compartment with respect to illumination of the compensatory compartment.

6. The MCD of claim 5, wherein the means for providing greater illumination of the holding compartment or the holding compartment and the alley compartment comprises one or more of:
lighting positioned to increase illumination of the holding compartment or to increase illumination of the holding compartment and the alley compartment with respect to illumination of the compensatory compartment;
at least a portion of the compensatory compartment comprising an opaque or tinted, transparent material; and
a cover or lid that blocks light from entering the compensatory compartment.

7. The MCD of claim 1, wherein at least a portion of the plurality of perforations in the floor in the enclosure also serve as ventilation holes.

8. The MCD of claim 1, further comprising panel walls separating the holding compartment and the compensatory compartment from the alley compartment, the panel walls independently moveable to open or close access between the respective compartments.

9. The MCD of claim 8, wherein the panel walls are slidingly engageable with one or more securing means placed between the holding compartment and the alley compartment and placed between the compensatory compartment and alley compartment.

10. The MCD of claim 1, wherein the holding compartment, alley compartment, and compensatory compartment each have a removable lid.

11. The MCD of claim 1, wherein the plurality of pins are arranged on the platform so that a laboratory animal cannot traverse the alley compartment floor when the pins are disposed through the perforations without at least a portion of one limb or paw making contact with one pin.

12. The MCD of claim 1, wherein the platform raising means can incrementally vary the extent of the pins disposed through the perforations.

13. The MCD of claim 1, wherein the platform raising means can raise the pins about 0.01 mm to about 20 mm above the alley floor.

14. The MCD of claim 1, wherein in addition to the noxious mechanical stimulus in the floor of the alley compartment, the compensatory compartment comprises a first stimulus for the animal or the holding compartment comprises a second stimulus for the animal, or both the compensatory compartment comprises the first stimulus and the holding compartment comprises the second stimulus.

15. The MCD of claim 14, wherein the first stimulus and the second stimulus are independently selected from the group consisting of: a different illumination, a food, a drug, a texture, a surface coating, a temperature difference, an odor, a sound, and combinations thereof.

16-17. (canceled)

18. The MCD of claim 1, wherein:
the enclosure comprises a tinted, transparent material;
the enclosure further comprises:
panel walls separating the holding compartment and the compensatory compartment from the alley compartment, the panel walls independently moveable to open or close access between the respective compartments; and
the MCD further comprises lighting operable to increase illumination of the holding compartment with respect to illumination of the compensatory compartment.

19-37. (canceled)

38. A conflict device operable to assess a physiologic experience in an animal, the device comprising:
an enclosure comprising:
a holding compartment;
a compensatory compartment; and
an alley compartment connecting the holding compartment to the compensatory compartment; and
a stimulus selected from the group consisting of: a thermal stimulus, an odor, a sound, an illumination, a food, a drug, a texture, a surface coating, and combinations thereof, in the alley compartment.

39. The conflict device of claim 38, further comprising actuating means to release or initiate an odor or a sound or an illumination when an animal enters the alley compartment.

40. The conflict device of claim 38, wherein the texture comprises projections with edges or points that contact a portion of an animal's limb or paw, thereby increasing pressure to that location versus contact of the limb or paw spread out over a flat surface.

41. The conflict device of claim 38, wherein the enclosure comprises a housing having a floor, wherein at least a portion of the floor is connected to a wall.

42. The conflict device of claim 38, wherein at least a portion of the enclosure comprises a transparent material or a tinted, transparent material.

43. (canceled)

44. The conflict device of claim 38, further comprising a means for providing greater illumination of the holding compartment or the holding compartment and the alley compartment with respect to illumination of the compensatory compartment.

45. The conflict device of claim 44, wherein the means for providing greater illumination of the holding compartment or the holding compartment and the alley compartment comprises one or more of:
lighting positioned to increase illumination of the holding compartment or to increase illumination of the holding compartment and the alley compartment with respect to illumination of the compensatory compartment;
at least a portion of the compensatory compartment comprising an opaque or tinted, transparent material; and
a cover or lid that blocks light from entering the compensatory compartment.

46. The conflict device of claim 38, wherein the enclosure includes at least one ventilation hole.

47. The conflict device of claim 38, further comprising panel walls separating the holding compartment and the compensatory compartment from the alley compartment, the panel walls independently moveable to open or close access between the respective compartments.

48. The conflict device of claim 47, wherein the panel walls are slidingly engageable with one or more securing means placed between the holding compartment and the alley compartment and placed between the compensatory compartment and alley compartment.

49. The conflict device of claim 38, wherein the holding compartment, alley compartment, and compensatory compartment each have a removable lid.

50. The conflict device of claim 38, wherein the stimulus in the alley compartment is a first stimulus and the compensatory compartment, the holding compartment, or both the compensatory compartment and the holding compartment comprises a second stimulus for the animal.

51. The conflict device of claim 50, wherein the second stimulus in the compensatory compartment or the holding compartment is independently selected from the group consisting of: a different illumination, a food, a drug, a texture, a surface coating, a temperature difference, an odor, a sound, and combinations thereof.

52-58. (canceled)

59. The MCD of claim 1, wherein the platform raising means is able to raise the pins to a plurality of heights differing in increments of 0.01 mm or greater.

60. The MCD of claim 1, wherein the platform raising means is able to raise the pins to a plurality of different heights, each height being in a range of 0.01 mm to about 20 mm above the alley floor.

61. The MCD of claim 1, wherein the platform raising means is able to raise the pins to a plurality of different heights, with at least one height being in a range of 0.01 mm to about 20 mm above the alley.

62. The MCD of claim 1, wherein the platform raising means is able to raise the pins to a height in a range of 0.01 mm to about 5 mm above the alley floor.

63. The MCD of claim 38, wherein the stimulus comprises a distinct texture or a distinct surface coating on the floor of the alley compartment, as compared to the holding compartment, the compensatory compartment, or both the holding compartment and the compensatory compartment.

64. A method of measuring pain related behaviors in a laboratory animal, the method comprising:
introducing the laboratory animal to a conflict device comprising an enclosure that comprises:
a holding compartment;
a compensatory compartment; and
an alley compartment connecting the holding compartment to the compensatory compartment;
exposing the laboratory animal to a stimulus selected from the group consisting of: a mechanical stimulus, a thermal stimulus, an odor, a sound, an illumination, a food, a drug, a texture, a surface coating, and combinations thereof, while the laboratory animal is located in the holding compartment, the alley compartment, or both; and
monitoring a position or movement of the laboratory animal within the enclosure in response to exposure to the stimulus.

65. The method of claim 64, wherein the monitoring of the position or movement comprises measuring at least one of:
latency of the laboratory animal to exit the holding compartment;
latency of the laboratory animal to enter the compensatory compartment; and
duration of an initial cross of the alley compartment by the laboratory animal or the total time the laboratory animal spends in the presence of the stimulus.

66. The method of claim 64, wherein:
the enclosure further comprises panel walls separating the holding compartment and the compensatory compartment from the alley compartment, the panel walls independently moveable to open or close access between the respective compartments, wherein the method further comprises:
placing the laboratory animal in the holding compartment with the panel wall separating the holding compartment and the alley compartment positioned to close access between the compartments; and
moving the panel wall separating the holding compartment and the alley compartment to a position to open access between the holding compartment and the alley compartment, wherein the panel wall separating the compensatory compartment and the alley compartment is positioned to open access between the compensatory compartment and the alley compartment.

67. The method of claim 64, wherein the alley compartment has a plurality of perforations disposed on a floor and the stimulus is a mechanical stimulus, wherein the conflict device further comprises a platform, a plurality of pins disposed on the platform, and a platform raising component that raises the plurality of pins through the plurality of perforations in the floor of the alley compartment, wherein the method further comprises:
raising the plurality of pins through the plurality of perforations in the floor of the alley compartment;
placing the laboratory animal in the holding compartment;
measuring at least one of:
latency of the laboratory animal to exit the holding compartment;
latency of the laboratory animal to enter the compensatory compartment; and
duration of an initial cross of the alley compartment by the laboratory animal or the total time the laboratory animal spent on the pins.

68. The method of claim 64, wherein the laboratory animal is conditioned by a conditioning method prior to the exposing, wherein the conditioning method comprises:
placing the laboratory animal in the holding compartment in the absence of the stimulus in the holding compartment, the alley compartment, or both the holding compartment and the alley compartment, to allow the animal to exit the holding compartment, traverse the alley compartment, and enter the compensatory compartment.

69. The method of claim 68, wherein the stimulus in the holding compartment, the alley compartment, or both is a first stimulus and the laboratory animal is further conditioned by providing a second stimulus in the compensatory compartment to encourage the laboratory animal to enter the compensatory compartment during the conditioning method.

70. The method of claim 69, wherein the stimulus in the holding compartment, the alley compartment, or both is a first stimulus and the second stimulus in the compensatory compartment is either (i) distinct from the first stimulus in the holding compartment, the alley compartment, or both or (ii) a different level or different amount of the first stimulus in the holding compartment, the alley compartment, or both.

71. The method of claim 64, wherein the laboratory animal is conditioned by a conditioning method prior to the exposing, the conditioning method comprising:
placing the laboratory animal in the holding compartment, where the stimulus is absent in the alley compartment, but present in the holding compartment, to encourage the animal to exit the holding compartment, traverse the alley compartment, and enter the compensatory compartment.

72. The method of claim 64, wherein the exposing of the laboratory animal to at least one stimulus comprising increasing illumination of the holding compartment or increasing illumination of the holding compartment and the alley compartment with respect to a level of illumination of the compensatory compartment.

73. The method of claim 64, wherein prior to the introducing of the laboratory animal into the conflict device, the laboratory animal is provided with a treatment selected from the group consisting of:
(i) a treatment intended to alleviate pain by administering an analgesic or a putative analgesic to the laboratory animal;
(ii) a treatment to increase pain sensitivity by causing a chronic constriction injury of a nerve or injection of a substance producing inflammation; and
any combinations thereof.

74. The method of claim 64, wherein the stimulus in the holding compartment, the alley compartment, or both is a first stimulus and the stimulus in the compensatory compartment is a second stimulus that is either (i) distinct from the first stimulus in the holding compartment, the alley compartment, or both or (ii) a different level or different amount of the first stimulus in the holding compartment, the alley compartment, or both.
